(19) United States
(12) Patent Application Publication
(10) Pub. No.: US 2026/0244724 A1
(43) Pub. Date: Aug. 20, 2026

(54) INFORMATION PROCESSING SYSTEM, INFORMATION PROCESSING METHOD, AND NON-TRANSITORY RECORDING MEDIUM

(71) Applicant: NEC Corporation, Tokyo (JP)

(72) Inventors: Yuta SHIMIZU, Tokyo (JP); Kazuki INAGAKI, Tokyo (JP); Toshinobu OGATSU, Tokyo (JP); Takahiro TOIZUMI, Tokyo (JP); Kosuke YOSHIMI, Tokyo (JP); Chisato FUNAYAMA, Tokyo (JP); Ryuichi AKASHI, Tokyo (JP)

(73) Assignee: NEC Corporation, Tokyo (JP)

(21) Appl. No.: 19/164,342

(22) PCT Filed: Mar. 27, 2023
(86) PCT No.: PCT/JP2023/012246

§ 371 Date: Sep. 11, 2025

(51) Int. Cl. G06F 21/32

(52) U.S. Cl. CPC G06F 21/32

(57) ABSTRACT

An information processing system includes: an acquisition unit that acquires first biometric information and second biometric information from a target, a first authentication unit that determines whether or not the target is authenticatable by first authentication using the first biometric information, a second authentication unit that determines whether or not the target is authenticatable by second authentication using the second biometric information, and a control unit that permits first processing in response to a determination that it is authenticatable in both the first authentication and the second authentication, that permits second processing in response to a determination that it is authenticatable in one of the first authentication and the second authentication, and that does not permit the first processing and the second processing in response to a determination that it is not authenticatable in both the first authentication and the second authentication.

### Technical Field

The present disclosure relates to technical fields of an information processing system, an information processing method, and a recording medium.

### BACKGROUND ART

There is known a technique/technology of permitting the execution of various types of processing in a vehicle in a case where a predetermined condition is satisfied. For example, Patent Literature 1 discloses a technique/technology of performing biometric authentication on a driver and providing a temporary key to permit driving. Patent Literature 2 discloses a technique/technology of permitting an engine to be started regardless of whether or not there is an ignition key, in a case where a vehicle is in a disaster area. Patent Literature 3 discloses a technique/technology of permitting a driver to start a vehicle engine, based on information read from a driver's license.

### CITATION LIST

### Patent Literature

Patent Literature 1: JP2008-120284A
Patent Literature 2: JP2006-144595A
Patent Literature 3: JP2005-096657A

### SUMMARY

### Technical Problem

The present disclosure aims to improve the techniques/technologies disclosed in Citation List.

### Solution to Problem

An information processing system according to an example aspect of the present disclosure includes: an acquisition unit that acquires first biometric information and second biometric information from a target using a moving body; a first authentication unit that determines whether or not the target is authenticatable by first authentication using the first biometric information; a second authentication unit that determines whether or not the target is authenticatable by second authentication using the second biometric information; and a control unit (i) that permits first processing in the moving body in response to a determination that it is authenticatable in both the first authentication and the second authentication, (ii) that permits second processing that is different from the first processing in response to a determination that it is authenticatable in one of the first authentication and the second authentication, and (iii) that does not permit the first processing and the second processing in response to a determination that it is not authenticatable in both the first authentication and the second authentication.

An information processing method according to an example aspect of the present disclosure is an information processing method that is executed by at least one computer, the information processing including: acquiring first biometric information and second biometric information from a target using a moving body; determining whether or not the target is authenticatable by first authentication using the first biometric information; determining whether or not the target is authenticatable by second authentication using the second biometric information; and (i) permitting first processing in the moving body in response to a determination that it is authenticatable in both the first authentication and the second authentication, (ii) permitting second processing that is different from the first processing in response to a determination that it is authenticatable in one of the first authentication and the second authentication, and (iii) not permitting the first processing and the second processing in response to a determination that it is not authenticatable in both the first authentication and the second authentication.

A recording medium according to an example aspect of the present disclosure is a recording medium on which a computer program that allows at least one computer to execute an information processing method is recorded, the information processing method including: acquiring first biometric information and second biometric information from a target using a moving body; determining whether or not the target is authenticatable by first authentication using the first biometric information; determining whether or not the target is authenticatable by second authentication using the second biometric information; and (i) permitting first processing in the moving body in response to a determination that it is authenticatable in both the first authentication and the second authentication, (ii) permitting second processing that is different from the first processing in response to a determination that it is authenticatable in one of the first authentication and the second authentication, and (iii) not permitting the first processing and the second processing in response to a determination that it is not authenticatable in both the first authentication and the second authentication.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a block diagram illustrating a functional configuration of an information processing system according to a second example embodiment.

FIG. 5 is a flowchart illustrating a flow of operation of the information processing system according to the second example embodiment.

FIG. 6 is a table illustrating processing permitted to each attribute in an information processing system according to a third example embodiment.

FIG. 7 is a table illustrating processing permitted to each attribute in an information processing system according to a fourth example embodiment.

FIG. 8 is a block diagram illustrating a functional configuration of an information processing system according to a fifth example embodiment.

FIG. 9 is a flowchart illustrating a flow of an abnormality determination operation in the information processing system according to the fifth example embodiment.

FIG. 10 is a flowchart illustrating a flow of an information disclosure operation in an information processing system according to a sixth example embodiment.

FIG. 11 is a flowchart illustrating a flow of an insurance renewal operation in an information processing system according to a seventh example embodiment.

FIG. 12 is a flowchart illustrating an insurance coverage determination operation in an information processing system according to an eighth example embodiment.

FIG. 13 is a flowchart illustrating a flow of operation of an information processing system according to a ninth example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

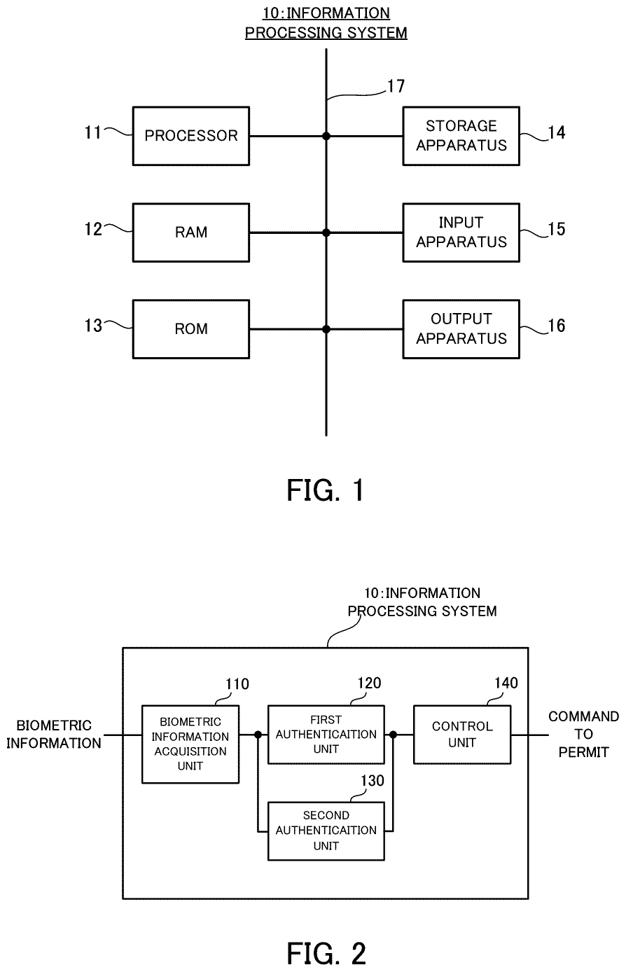

An information processing system according to a first example embodiment will be described with reference to FIG. 1 to FIG. 3.

### Hardware Configuration

First, with reference to FIG. 1, a hardware configuration of the information processing system according to the first example embodiment will be described. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, and a ROM (Read Only Memory) 13. The information processing system 10 may further include a storage apparatus 14, an input apparatus 15, and an output apparatus 16. The processor 11, the RAM 12, the ROM 13, the storage apparatus 14, the input apparatus 15, and the output apparatus 16 described above are connected via a data bus 17.

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may acquire (i.e., read) a computer program from a not-illustrated apparatus disposed outside the information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a function block for performing biometric authentication and permitting various types of processing in a moving body is realized in the processor 11. That is, the processor 11 may function as a controller that performs each control in the information processing system 10.

The processor 11 may be configured as, for example, a CPU (Central Processing Unit), a GPU (Graphics Processing Unit), a FPGA (Field-Programmable Gate Array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the information processing system 10 for a long time. The storage apparatus 14 may operate as a transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be configured as a portable terminal such as a smartphone and a tablet. The output apparatus 16 may also be an apparatus that outputs information in a format other than an image. For example, the output apparatus 16 may be a speaker that audio-outputs the information about the information processing system 10.

A part of the hardware described in FIG. 1 may be provided as an external apparatus of the information processing system 10. For example, the information processing system 10 may be configured to include only the processor 11, the RAM 12, and the ROM 13 described above. The other components (i.e., the storage apparatus 14, the input apparatus 15, and the output apparatus 16) may be provided in an external apparatus connected to the information processing system 10. In addition, the information processing system 10 may realize a part of an arithmetic function by using an external apparatus (e.g., an external server or cloud, etc.).

### Functional Configuration

Next, with reference to FIG. 2, a functional configuration of the information processing system 10 according to the first example embodiment will be described. FIG. 2 is a block diagram illustrating the functional configuration of the information processing system according to the first example embodiment.

The information processing system 10 according to the first example embodiment is configured to perform authentication using biometric information on a target using a moving body and to permit various types of processing in the moving body. An example of the moving body is a vehicle such as an automobile. The moving body may include public transport vehicles such as buses and trains. The moving body may also include a moving body that is different from general vehicles (e.g., ships and aircraft). The target using the moving body may include not only a driver who drives the moving body, but also a fellow passenger or a passenger in the moving body, people who intend to load luggage into the moving body, and so on.

As illustrated in FIG. 2, the information processing system 10 according to the first example embodiment includes, as components for realizing its functions, a biometric information acquisition unit 110, a first authentication unit 120, a second authentication unit 130, and a control unit 140. Each of the biometric information acquisition unit 110, the first authentication unit 120, the second authentication unit 130, and the control unit 140 may be a processing block realized, for example, by the processor 11 described above (see FIG. 1).

The biometric information acquisition unit 110 is configured to acquire first biometric information and second biometric information from the target using the moving body. The first biometric information and the second biometric information are different from each other. For example, the first biometric information may be information about a face of the target, and the second biometric information may be information about an iris of the target. The biometric information acquisition unit 110 may acquire the first biometric information and the second biometric information from an image of the target captured. In this case, the information processing system 10 may include a camera that captures the target. The first biometric information and the second biometric information may be feature quantities extracted from the image. The first biometric information acquired by the biometric information acquisition unit 110 is outputted to the first authentication unit 120. The second biometric information acquired by the biometric information acquisition unit 110 is outputted to the second authentication unit 130.

The first authentication unit 120 is configured to perform first authentication using the first biometric information acquired by the biometric information acquisition unit 110 and to determine whether or not the target is authenticatable. The first authentication unit 120 may, for example, authenticate the target based on a degree of matching between the first biometric information acquired from the target and the biometric information registered in advance. The first authentication may be face authentication using information about the face of the target. The first authentication unit 120 may determine that the first authentication is failed in a case where the first biometric information is not acquired normally by the biometric information acquisition unit 110. A result of the first authentication by the first authentication unit 120 is outputted to the control unit 140.

The second authentication unit 130 is configured to perform second authentication using the second biometric information acquired by the biometric information acquisition unit 110 and to determine whether or not the target is authenticatable. The second authentication unit 130 may, for example, authenticate the target based on a degree of matching between the second biometric information acquired from the target and the biometric information registered in advance. The second authentication may be iris authentication using information about the iris of the target. The second authentication unit 130 may determine that the second authentication is failed in a case where the second biometric information is not acquired normally by the biometric information acquisition unit 110. A result of the second authentication by the second authentication unit 130 is outputted to the control unit 140.

The control unit 140 is configured to permit various types of processing in the moving body, based on the result of the first authentication by the first authentication unit 120 and the result of the second authentication by the second authentication unit 130. Specifically, the control unit 140 permits different types of processing, depending on whether both the first authentication and the second authentication are successful, one of the first authentication and the second authentication is successful, or both the first authentication and the second authentication are failed. A more specific operation of the control unit 140 will be described in detail in the following flow of operation.

### Flow of Operation

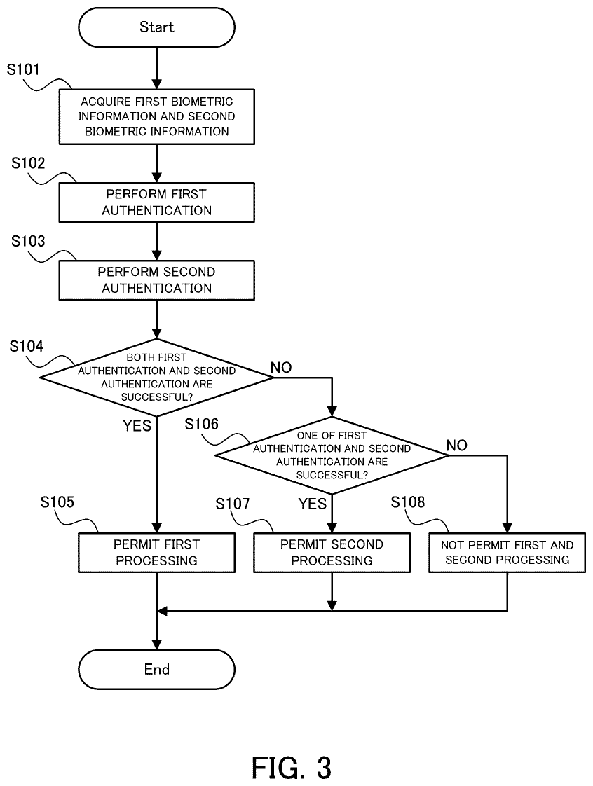

Next, with reference to FIG. 3, a flow of operation of the information processing system 10 according to the first example embodiment will be described. FIG. 3 is a flowchart illustrating the flow of the operation of the information processing system according to the first example embodiment.

As illustrated in FIG. 3, when the operation by the information processing system 10 according to the first example embodiment is started, first, the biometric information acquisition unit 110 acquires the first biometric information and the second biometric information from the target (step S101). The timing of acquiring the first biometric information and the second biometric information is not particularly limited, but, for example, the biometric information acquisition unit 110 may acquire the first biometric information and the second biometric information when the target approaches the moving body. Alternatively, the biometric information acquisition unit 110 may acquire the first biometric information and the second biometric information when the target gets in the moving body. Alternatively, the biometric information acquisition unit 110 may acquire the first biometric information and the second biometric information when the target performs a predetermined operation.

Then, the first authentication unit 120 performs the first authentication by using the first biometric information acquired by the biometric information acquisition unit 110 (step S102). In addition, the second authentication unit 130 performs the second authentication by using the second biometric information acquired by the biometric information acquisition unit 110 (step S103). The first authentication and the second authentication may be performed in succession to each other or simultaneously in parallel.

Then, the control unit 140 determines whether or not both the first authentication by the first authentication unit 120 and the second authentication by the second authentication unit 130 are successful (step S104). In a case where it is determined that both the first authentication and the second authentication are successful (step S104: YES), the control unit 140 permits first processing in the moving body (step S105). The first processing may include a plurality of types of processing. When the control unit 140 permits the first processing, it may automatically perform the first processing. Alternatively, after permitting the first processing, the control unit 140 may perform the first processing in the timing when the target performs an operation of performing the first processing. A specific example of the first processing will be described in detail in another example embodiment later.

On the other hand, in a case where it is determined that both the first authentication and the second authentication are not successful (step S104: NO), the control unit 140 determines whether or not one of the first authentication by the first authentication unit 120 and the second authentication by the second authentication unit 130 is successful (step S106). Then, in a case where it is determined that one of the first authentication and the second authentication is successful (step S106: YES), the control unit 140 permits second processing in the moving body (step S107). The second processing is different from the first processing. The second process may include a plurality of types of processing. In this case, a part of the plurality of types of processing included in the second process may overlap with a part of the plurality of types of processing included in the first processing. When the control unit 140 permits the second processing, it may automatically perform the second processing. Alternatively, after permitting the second processing, the control unit 140 may perform the second processing in the timing when the target performs an operation of performing the second processing. A specific example of the second processing will be described in detail in another example embodiment later.

On the other hand, in a case where it is determined that neither the first authentication nor the second authentication is successful (step S104: NO), the control unit 140 does not permit the first processing and the second processing in the moving body (step S108). In other words, the control unit 140 may prohibit the first processing and the second processing. The control unit 140 may permit third processing that is different from both the first processing and the second processing in a case where it does not permit the first processing and the second processing in the moving body.

### Technical Effect

Next, a technical effect obtained by the information processing system 10 according to the first example embodiment will be described.

As described in FIG. 1 to FIG. 3, in the information processing system 10 according to the first example embodiment, the first processing and the second processing in the moving body are permitted based on the result of the first authentication using the first biometric information and the result of the second authentication using the second biometric information. In this way, it is possible to appropriately permit various types of processing in the moving body. For example, by setting, as the first processing, processing that requires high security such as payment processing, or processing that involves human life, it is possible to permit the first and second processing only when both the first authentication and the second authentication are successful. In addition, by setting, as second processing, processing that requires somewhat lower security or processing that is unlikely to involve human life, it is possible to permit the first and second processing even when one of the first authentication and the second authentication is successful.

### Second Example Embodiment

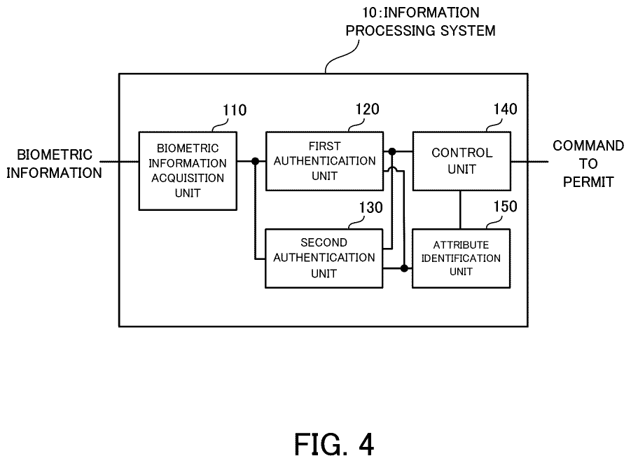

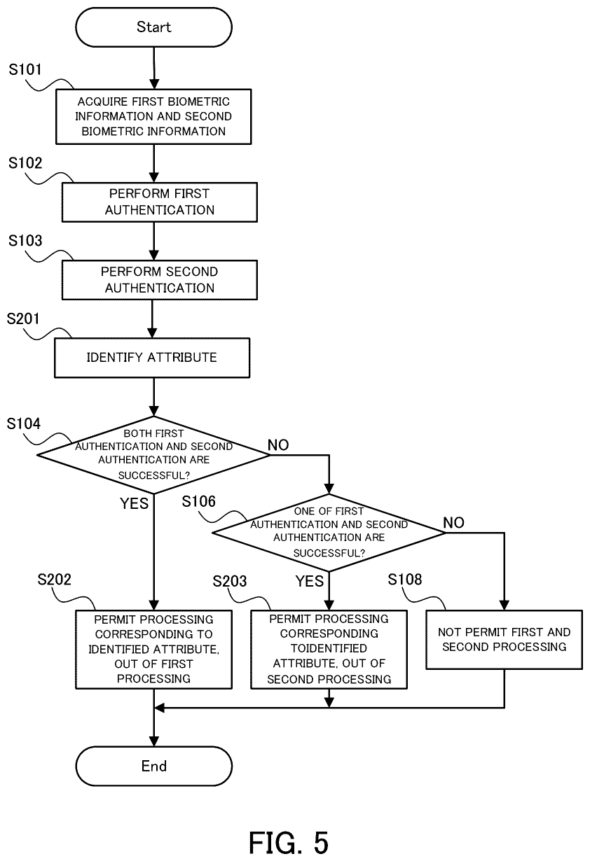

The information processing system 10 according to a second example embodiment will be described with reference to FIG. 4 and FIG. 5. The second example embodiment partially differs from the first example embodiment described above only in its configuration and operation, and may be the same as the first example embodiment in the other parts. For this reason, a part differing from the first example embodiment already described will be described in detail below, and a description of the other overlapping parts will be omitted as appropriate.

### Functional Configuration

First, with reference to FIG. 4, a functional configuration of the information processing system 10 according to the second example embodiment will be described. FIG. 4 is a block diagram illustrating the functional configuration of the information processing system according to the first example embodiment. In FIG. 4, the same components as those illustrated in FIG. 2 carry the same reference numerals.

As illustrated in FIG. 4, the information processing system 10 according to the first example embodiment includes, as components for realizing its functions, the biometric information acquisition unit 110, the first authentication unit 120, the second authentication unit 130, the control unit 140, and an attribute identification unit 150. That is, the information processing system 10 according to the second example embodiment further includes the attribute identification unit 150 in addition to the configuration in the first example embodiment (see FIG. 2). The attribute identification unit 150 may be a processing block realized, for example, by the processor 11 described above (see FIG. 1).

The attribute identification unit 150 is configured to identify an attribute of the target, based on at least one of the result of the first authentication by the first authentication unit 120 and the result of the second authentication by the second authentication unit 130. The attribute identification unit 150 may identify the attribute of the target by identifying the target (individual) in the first authentication and the second authentication, and reading attribute information stored in association with the identified target. The type of the attribute is not particularly limited, but may, for example, indicate a family relationship such as “father,” “mother,” and “child,” or a role in the moving body such as “driver,” “fellow passenger,” and “passenger.” The attribute identification section 150 may identify a plurality of attributes for a single target. For example, the attribute identification section 150 may identify the attribute of the target as “father” and “driver.” Information about the attribute identified by the attribute identification section 150 is outputted to the control section 140.

### Flow of Operation

Next, with reference to FIG. 5, a flow of operation of the information processing system 10 according to the second example embodiment will be described. FIG. 5 is a flowchart illustrating the flow of the operation of the information processing system according to the second example embodiment. In FIG. 5, the same steps as those described in FIG. 3 carry the same reference numerals.

As illustrated in FIG. 5, when the operation of the information processing system 10 according to the second example embodiment is started, first, the biometric information acquisition unit 110 acquires the first biometric information and the second biometric information from the target (step S101). Then, the first authentication unit 120 performs the first authentication by using the first biometric information acquired by the biometric information acquisition unit 110 (step S102). In addition, the second authentication unit 130 performs the second authentication by using the second biometric information acquired by the biometric information acquisition unit 110 (step S103).

Then, the attribute identification unit 150 identifies the attributes of the target, based on the result of at least one of the first authentication by the first authentication unit 120 and the second authentication by the second authentication unit 130 (step S 201) (step S201).

Then, the control unit 140 determines whether or not both the first authentication by the first authentication unit 120 and the second authentication by the second authentication unit 130 are successful (step S104). In a case where it is determined that both the first authentication and the second authentication are successful (step S104: YES), the control unit 140 permits processing corresponding to the attribute identified by the attribute identification unit 150, out of the plurality of types of processing included in the first processing (step S202). That is, the control unit 140 permits only the processing corresponding to the attribute of the target, which is a part of the plurality of types of processing included in the first processing. The processing corresponding to each attribute in the first processing may be set in advance depending on the nature of the attribute.

On the other hand, in a case where it is determined that both the first authentication and the second authentication are not successful (step S104: NO), the control unit 140 determines whether or not one of the first authentication by the first authentication unit 120 and the second authentication by the second authentication unit 130 is successful (step S106). Then, in a case where it is determined that one of the first authentication and the second authentication is successful (step S106: YES), the control unit 140 permits the processing corresponding to the attribute identified by the attribute identification unit 150, out of the plurality of types of processing included in the second processing (step S203). That is, the control unit 140 permits only the processing corresponding to the attribute of the target, which is a part of the plurality of types of processing included in the second processing. The processing corresponding to each attribute in the second processing may be set in advance depending on the nature of the attribute.

On the other hand, in a case where it is determined that neither the first authentication nor the second authentication is successful (step S104: NO), the control unit 140 does not permit the first processing and the second processing in the moving body (step S108).

### Technical Effect

Next, a technical effect obtained by the information processing system 10 according to the second example embodiment will be described.

As described in FIG. 4 and FIG. 5, in the information processing system 10 according to the second example embodiment, the execution of various types of processing in the moving body is permitted by taking into account the attribute of the target, in addition to the results of the first authentication and the second authentication. In this way, it is possible to permit the execution of various types of processing, more flexibly, depending on the attribute of the target. A specific example of the processing permitted depending on the attribute will be described in detail in another example embodiment later.

### Third Example Embodiment

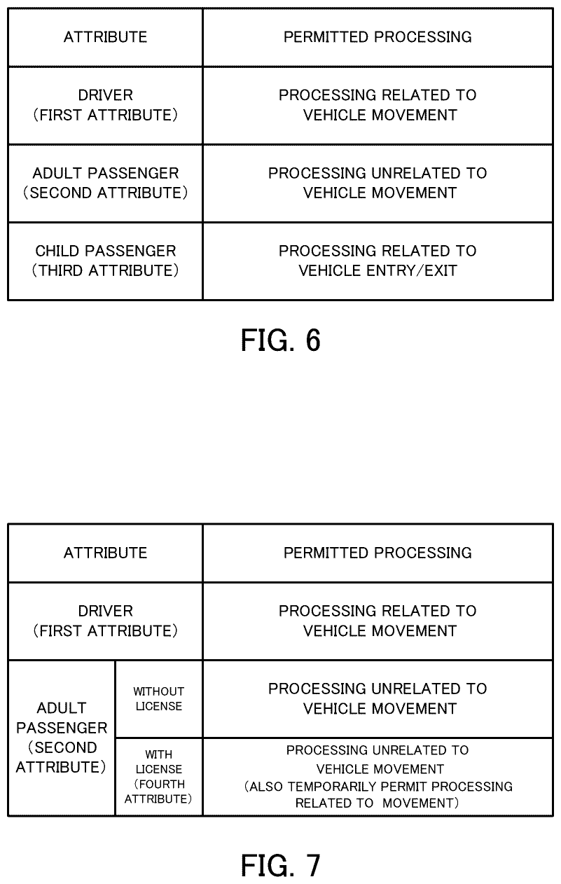

The information processing system 10 according to a third example embodiment will be described with reference to FIG. 6. The third example embodiment describes a specific example of the processing permitted in the second example embodiment described above, and may be the same as the first and second example embodiments in its configuration and operation. For this reason, a part differing from each of the example embodiments described above will be described in detail below, and a description of the other overlapping parts will be omitted as appropriate.

### Processing Corresponding to Attribute

First, with reference to FIG. 6, the processing permitted in the information processing system 10 according to the third example embodiment will be specifically described. FIG. 6 is a table illustrating the processing permitted to each attribute in the information processing system according to the third example embodiment.

In FIG. 6, in the information processing system 10 according to the third example embodiment, a description will be made on the assumption that the moving body is a vehicle (the same applies to the subsequent example embodiments). In the information processing system 10 according to the third example embodiment, a first attribute, a second attribute, and a third attribute are set as the attribute of the target. The first attribute is an attribute indicating that the target is a driver of the vehicle. The second attribute is an attribute indicating that the target is an adult passenger. The third attribute is an attribute indicating that the target is a child passenger.

The processing permitted to the target with the first attribute (i.e., the driver) is processing related to vehicle movement. The processing related to the vehicle movement include, for example, starting an engine of the vehicle, operating an accelerator, brakes, and a steering wheel of the vehicle, switching between automated/autonomous driving and manual driving in a vehicle capable of self-driving, and the like.

The processing permitted to the target with the second attribute (i.e., the adult passenger) is processing unrelated to the vehicle movement. That is, the processing permitted to the target with the second attribute is processing other than the processing related to the vehicle movement that is permitted to the target with the first attribute. The processing unrelated to the vehicle movement includes, for example, unlocking doors of the vehicle, opening or closing doors, a trunk, and a fuel door of the vehicle, operating an air conditioner, a music player, a car navigation system or the like installed in the vehicle, turning on lights of the vehicle, opening or closing storage boxes of the vehicle (such as a console box, a glove box, etc.), retrieving video data from an in-vehicle camera, updating software of the vehicle, renting out the vehicle as a rental car, activating a child lock, and the like.

The processing unrelated to the vehicle movement permitted to the target with the second attribute, may be set to be permitted separately depending on more detailed attributes included in the second attribute. For example, the processing of opening or closing the glove box may be permitted to a “passenger seated in a front passenger seat,” and the processing of opening or closing the console box may be permitted to a “passenger seated in a rear seat.”

In addition, the processing unrelated to the vehicle movement permitted to the second attribute may be permitted to the target with the first attribute. That is, both the processing unrelated to the vehicle movement and the processing related to the vehicle movement may be permitted to the target with the first attribute. It is preferable, however, that processing that should not be performed while the vehicle is being driven (e.g., the processing of operating the car navigation system, etc.) not be permitted to the target with the first attribute.

The processing permitted to the target with the third attribute (i.e., the child passenger) is processing related to vehicle entry/exit. The processing related to the vehicle entry/exit includes unlocking the doors of the vehicle, and opening or closing the doors of the vehicle. The processing related to the vehicle entry/exit is included in the processing unrelated to the vehicle movement. That is, the processing related to the vehicle entry/exit, which is a part of the processing unrelated to the vehicle movement permitted to the target with the second attribute, is permitted to the target with the third attribute.

### Technical Effect

Next, a technical effect obtained by the information processing system 10 according to the third example embodiment will be described.

As described in FIG. 6, in the information processing system 10 according to the third example embodiment, different types of processing are permitted to the targets with the first attribute, the second attribute, and the third attribute, respectively. In this way, various types of processing in the vehicle may be appropriately permitted to the driver of the vehicle and to the adult passenger and the child passenger. More specifically, the processing related to the vehicle movement may be permitted only to the driver, while the processing related to the vehicle movement may not be permitted to the passengers other than the driver. The processing related to the vehicle movement (driving) may, for example, involve life-threatening situations in the event of an accident. Therefore, vehicle safety may be enhanced by permitting the processing related to the vehicle movement only to the driver. On the other hand, the processing unrelated to the vehicle movement is less dangerous than the processing related to the vehicle movement. Therefore, it is unlikely to cause a major problem even if the processing unrelated to the vehicle movement is permitted to the adult passenger. However, permitting all the processing unrelated to the vehicle movement even to the child passenger, may lead to unexpected accidents in the event of incorrect operation or the like. Therefore, vehicle safety may be further enhanced by permitting only the processing related to the vehicle entry/exit to the child passenger.

### Fourth Example Embodiment

The information processing system 10 according to a fourth example embodiment will be described with reference to FIG. 7. The fourth example embodiment describes a specific example of the permitted processing as in the third example embodiment described above, and may be the same as the first and second example embodiments in its configuration and operation. For this reason, a part differing from each of the example embodiments described above will be described in detail below, and a description of the other overlapping parts will be omitted as appropriate.

### Processing Corresponding to Attribute

First, with reference to FIG. 7, the processing permitted in the information processing system 10 according to the fourth example embodiment specifically described. FIG. 7 is a table illustrating the processing permitted to each attribute in the information processing system according to the fourth example embodiment.

As illustrated in FIG. 7, in the information processing system 10 according to the fourth example embodiment, a fourth attribute is set as the attribute included in the second attribute (i.e., the adult passenger). The fourth attribute is an attribute indicating that the target is a passenger having a driver's license for the vehicle.

As described in the third example embodiment, the processing unrelated to the vehicle movement is permitted to the target with the second attribute (i.e., the adult passenger). In the present example embodiment, processing related to vehicle movement is also temporarily permitted to the target with the fourth attribute (i.e., the passenger having a driver's license), depending on the situation. Specifically, the processing related to the vehicle movement is permitted to the target with the fourth attribute in a case where the driver has an abnormality that makes it difficult to continue driving, or in a case where permission to drive the vehicle is given by the driver. In this case, the target with the fourth attribute may perform the processing related to the vehicle movement, in place of the driver. For example, in a case where the driver has an abnormality (more specifically, in a case where the driver has a sudden seizure or is dozing off, etc.), the target with the fourth attribute may operate the steering wheel or brakes from the front passenger seat. Additionally, in a case where the driver permits the target with the fourth attribute to drive the vehicle, the driver and the target with the fourth attribute may take turns driving as needed.

### Technical Effect

Next, a technical effect obtained by the information processing system 10 according to the fourth example embodiment will be described.

As described in FIG. 7, in the information processing system 10 according to the fourth example embodiment, the processing related to the vehicle movement is permitted to the target with the fourth attribute, depending on the situation. In this way, in case of emergency or when the driver is tired or in similar cases, the adult passenger having a driver's license may perform operations related to the vehicle movement, in place of the driver.

### Fifth Example Embodiment

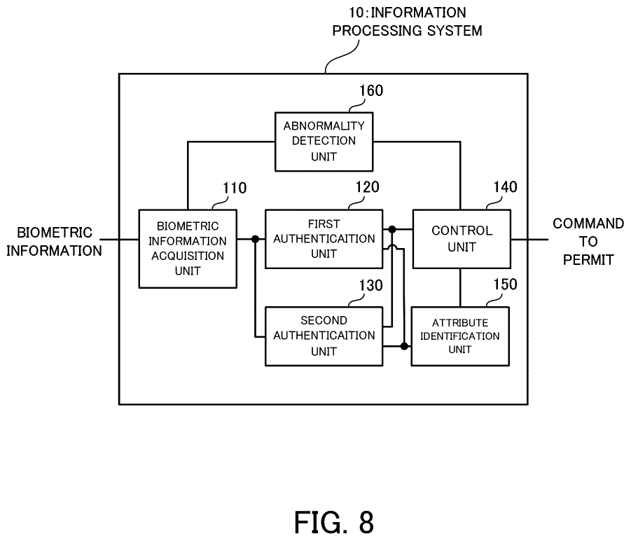

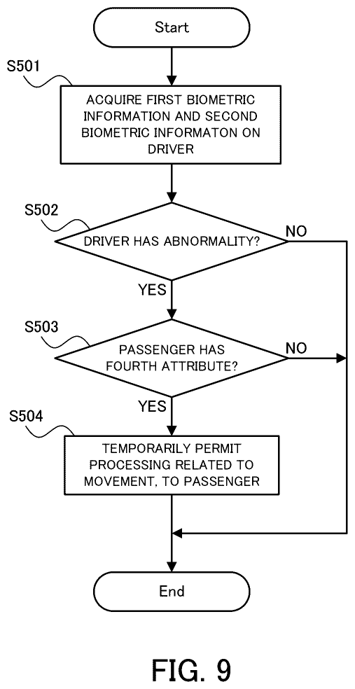

The information processing system 10 according to a fifth example embodiment will be described with reference to FIG. 8 and FIG. 9. The fifth example embodiment partially differs from the first to fourth example embodiments described above only in its configuration and operation, and may be the same as the first to fourth example embodiments in the other parts. For this reason, a part differing from each of the example embodiments described above will be described in detail below, and a description of the other overlapping parts will be omitted as appropriate.

### Functional Configuration

First, with reference to FIG. 8, a functional configuration of the information processing system 10 according to the fifth example embodiment will be described. FIG. 8 is a block diagram illustrating the functional configuration of the information processing system according to the fifth example embodiment. In FIG. 8, the same components as those described in FIG. 4 carry the same reference numerals.

As illustrated in FIG. 8, the information processing system 10 according to the fifth example embodiment includes, as components for realizing its functions, the biometric information acquisition unit 110, the first authentication unit 120, the second authentication unit 130, the control unit 140, the attribute identification unit 150, and an abnormality detection unit 160. That is, the information processing system 10 according to the fifth example embodiment further includes the abnormality detection unit 160 in addition to the configuration in the second example embodiment (see FIG. 4). The abnormality detection unit 160 may be a processing block realized, for example, by the processor 11 described above (see FIG. 1).

The abnormality detection unit 160 is configured to detect that the driver has an abnormality, based on at least one of the first biometric information and the second biometric information acquired by the biometric information acquisition unit 110 from the target (in this case, the driver). For example, the abnormality detection unit 160 may detect that the driver is unconscious, that the driver is asleep, or the like, based on information about the driver's face or eyes. A detailed description of a specific method of detecting an abnormality from the biometric information is omitted here, as the method can adopt existing techniques/technologies as appropriate. A detection result of the abnormality detection unit 160 is outputted to the control unit 140.

### Abnormality Determination Operation

Next, with reference to FIG. 9, a flow of an abnormality determination operation (i.e., an operation related to processing of detecting an abnormality of the driver) in the information processing system 10 according to the fifth example embodiment will be described. FIG. 9 is a flowchart illustrating the flow of the abnormality determination operation in the information processing system according to the fifth example embodiment.

As illustrated in FIG. 9, in the abnormality determination operation in the information processing system 10 according to the fifth example embodiment, first, the biometric information acquisition unit 110 acquires the first biometric information and the second biometric information from the driver (step S501). The first biometric information and the second biometric information acquired here may be acquired to be used in the first authentication and the second authentication, or may be acquired in different timing from the first authentication and the second authentication.

Then, the abnormality detection unit 160 detects that the driver has an abnormality, based on at least one of the first biometric information and the second biometric information (step S502). In a case where no abnormality is detected by the abnormality detection unit 160 (step S502: NO), the subsequent processing may be omitted, and the abnormality determination operation may be terminated.

In a case where the abnormality is detected by the abnormality detection unit 160 (step S502: YES), the control unit 140 determines whether or not a passenger in the vehicle has the fourth attribute (step S503). That is, the control unit 140 determines whether or not there is a passenger having a driver's license in the vehicle. In a case where the passenger in the vehicle has the fourth attribute (step S503: YES), the control unit 140 temporarily permits the processing related to the vehicle movement, to the passenger with the fourth attribute (step S504).

In a case where the passenger in the vehicle does not have the fourth attribute (step S503: NO), the processing described in the step S504 is omitted. That is, the processing related to the vehicle movement is not permitted to the passenger. However, in a case where the abnormality occurring to the driver is highly dangerous, the control unit 140 may perform processing such as bringing the vehicle to an emergency stop.

### Technical Effect

Next, a technical effect obtained by the information processing system 10 according to the fifth example embodiment will be described.

As described in FIG. 8 and FIG. 9, in the information processing system 10 according to the fifth example embodiment, the abnormality of the driver in the vehicle is detected based on at least one of the first biometric information and the second biometric information. In this way, it is possible to appropriately detect the abnormality of the driver and to permit the passenger to perform the processing related to the driving of the vehicle. In particular, the information processing system 10 according to the present example embodiment is configured to acquire the first biometric information and the second biometric information to be used in the first authentication and the second authentication, and therefore, the use of them makes it possible to reduce/control an increase in a cost for the abnormality detection.

### Sixth Example Embodiment

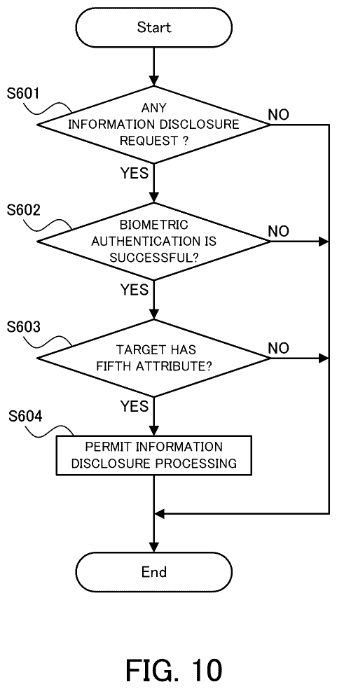

The information processing system 10 according to a sixth example embodiment will be described with reference to FIG. 10. The sixth example embodiment partially differs from the first to fifth example embodiments described above only in its operation, and may be the same as the first to fifth example embodiments in the other parts. For this reason, a part differing from each of the example embodiments described above will be described in detail below, and a description of the other overlapping parts will be omitted as appropriate.

### Information Disclosure Operation

First, with reference to FIG. 10, a flow of an information disclosure operation (i.e., an operation related to processing of disclosing vehicle information depending on the attribute) in the information processing system 10 according to the sixth example embodiment will be described. FIG. 10 is a flowchart illustrating the flow of the information disclosure operation in the information processing system according to the sixth example embodiment.

In FIG. 10, the information disclosure operation in the information processing system 10 according to the sixth example embodiment is an operation performed when information about the vehicle is disclosed. The information about the vehicle disclosed here is highly confidential information that should not be disclosed to anyone other than an owner of the vehicle. Specific examples of the information about the vehicle may be a vehicle registration number, information about the vehicle's insurance, or the like.

In the information disclosure operation, first, the control unit 140 determines whether or not there is an information disclosure request (step S601). The information disclosure request may be made, for example, by the passenger in the vehicle, and may be made by performing a specific operation in the vehicle. Alternatively, the information disclosure request may be transmitted from outside the vehicle by using a portable terminal (e.g., a smartphone). In a case where it is determined that there is no information disclosure request (step S601: NO), the subsequent processing is omitted and the information disclosure operation is ended.

In a case where it is determined that there is an information disclosure request (step S601: YES), the control unit 140 determines whether or not the first authentication and the second authentication of the target (specifically, a target requesting the information disclosure) are successful (step S602). At this time, in a case where information disclosure processing is set as the first processing, the control unit 140 may determine whether or not both the first processing and the second authentication are successful. In a case where the information disclosure processing is set as the second processing, the control unit 140 may determine whether or not one of the first processing and the second authentication is successful. In a case where it is determined that the first authentication and the second authentication are not successful (step S602: NO), the subsequent processing is omitted and the information disclosure operation is ended.

In a case where it is determined that the first authentication and the second authentication are successful (step S602: YES), the control unit 140 determines whether or not the attribute of the target is the fifth attribute (step S603). The fifth attribute here is an attribute indicating that the target is the vehicle owner. Even if the target is not the vehicle owner, the target may have the fifth attribute if the target is appropriate as a target to whom the information about the vehicle is disclosed. For example, a spouse of the vehicle owner may have the fifth attribute.

In a case where it is determined that the attribute of the target is the fifth attribute (step S603: YES), the control unit 140 permits the information disclosure processing of disclosing the information about the vehicle (step S604). In a case where the information disclosure processing is permitted to example, the information about the vehicle that is a disclosure object may be displayed on a display inside the vehicle or the like. In a case where the disclosure object is the vehicle registration number and the vehicle registration number is written in the hood of the vehicle, the control unit 140 may open the hood of the vehicle. In a case where there are people around, the information disclosure processing may be temporarily not permitted in order to prevent peeping or the like. In a case where it is determined that the attribute of the target is not the fifth attribute (step S603: NO), the step S604 described above is omitted. That is, the information disclosure processing is not permitted.

### Technical Effect

Next, a technical effect obtained by the information processing system 10 according to the sixth example embodiment will be described.

As described in FIG. 10, in the information processing system 10 according to the sixth example embodiment, the processing of disclosing the information about the vehicle is permitted in a case where the target has the fifth attribute. In this way, it is possible to disclose highly confidential information about the vehicle, only to the vehicle owner.

### Seventh Example Embodiment

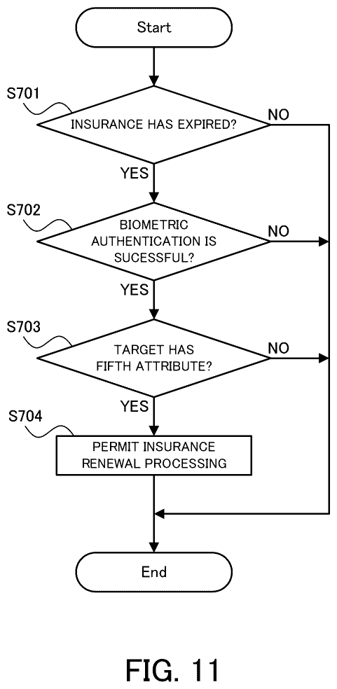

The information processing system 10 according to a seventh example embodiment will be described with reference to FIG. 11. The seventh example embodiment partially differs from the first to sixth example embodiments described above only in its operation, and may be the same as the first to sixth example embodiments in the other parts. For this reason, a part differing from each of the example embodiments described above will be described in detail below, and a description of the other overlapping parts will be omitted as appropriate.

### Insurance Renewal Operation

First, with reference to FIG. 11, a flow of an insurance renewal operation (i.e., an operation related to processing of renewing the insurance of the vehicle depending on the attribute) in the information processing system 10 according to the seventh example embodiment will be described. FIG. 11 is a flowchart illustrating the flow of the insurance renewal operation in the information processing system according to the seventh example embodiment.

As illustrated in FIG. 11, in the insurance renewal operation in the information processing system 10 according to the seventh example embodiment, first, the control unit 140 determines whether or not vehicle insurance has expired (step S701). The control unit 140 may determine whether the insurance has expired, for example, by comparing an expiration date of the insurance stored in advance with a current date. In a case where it is determined that the insurance has not expired (step S701: NO), the subsequent processing is omitted and the insurance renewal operation is ended.

In a case where it is determined that the insurance has expired (step S701: YES), the control unit 140 determines whether or not the first authentication and second authentication of the target are successful (step S702). At this time, in a case where processing of renewing the insurance (hereinafter referred to as “insurance renewal processing” as appropriate) described later is set as the first processing, the control unit 140 determines whether or not both the first processing and the second authentication are successful. In a case where the insurance renewal processing is set as the second processing, the control unit 140 may determine whether or not one of t the first processing and the second authentication is successful. In a case where it is determined that the first authentication and the second authentication are not successful (step S702: NO), the subsequent processing is omitted and the insurance renewal operation is ended.

In a case where it is determined that the first authentication and the second authentication are successful (step S702: YES), the control unit 140 determines whether or not the attribute of the target is the fifth attribute (step S703). As described in the sixth example embodiment described above, the fifth attribute is an attribute indicating that the target is the vehicle owner.

In a case where it is determined that the target is the fifth attribute (step S703: YES), the control unit 140 permits the insurance renewal processing of the vehicle (step S704). For example, the control unit 140 outputs a message to the target, such as “Your insurance has expired. Would you like to renew your insurance?”. Then, in a case where the target agrees to the message, the control unit 140 performs the insurance renewal processing. Alternatively, in a case where it is determined that the target is the fifth attribute, the control unit 140 may automatically perform the insurance renewal processing without confirming with the target. In a case where it is determined that the target is not the fifth attribute (step S703: NO), the step S704 described above is omitted. That is, the insurance renewal processing is not permitted.

### Technical Effect

Next, a technical effect obtained by the information processing system 10 according to the seventh example embodiment will be described.

As described in FIG. 11, in the information processing system 10 according to the seventh example embodiment, the insurance renewal processing is permitted when the target has the fifth attribute. In this way, it is possible to prevent the vehicle from being driven with expired insurance.

### Eighth Example Embodiment

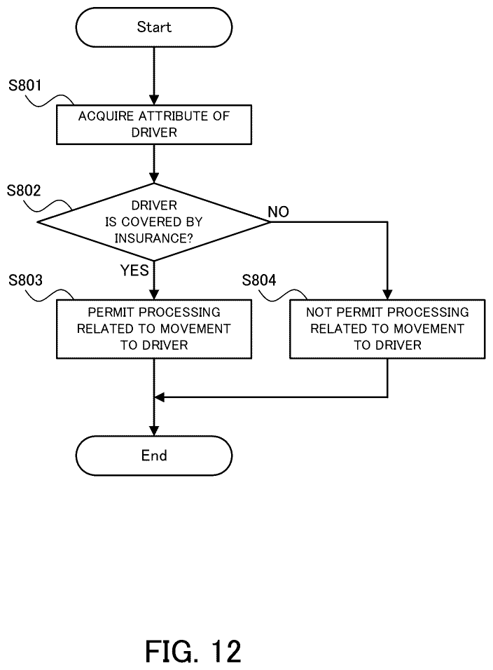

The information processing system 10 according to an eighth example embodiment will be described with reference to FIG. 12. The eighth example embodiment partially differs from the first to seventh example embodiments described above only in its operation, and may be the same as the first to seventh example embodiments in the other parts. For this reason, a part differing from each of the example embodiments described above will be described in detail below, and a description of the other overlapping parts will be omitted as appropriate.

### Insurance Coverage Determination Operation

First, with reference to FIG. 12, a flow of an insurance coverage determination operation (i.e., an operation related to processing of determining whether or not the driver is covered by the vehicle insurance depending on the attribute of the driver) in the information processing system 10 according to the eighth example embodiment will be described. FIG. 12 is a flowchart illustrating the flow of the insurance coverage determination operation in the information processing system according to the eighth example embodiment.

As illustrated in FIG. 12, in the insurance applicability determination operation in the information processing system 10 according to the eighth example embodiment, first, the control unit 140 acquires the attribute of the driver of the vehicle (step S801). The attribute of the driver is identified in advance by the attribute identification unit 150. The attribute acquired here is an attribute that allows the determination of whether or not the driver is covered by the insurance of the vehicle. For example, the control unit 140 may acquire an attribute indicating an owner of the vehicle covered by the insurance, an attribute indicating a spouse of the vehicle owner, an attribute indicating a child of the vehicle owner, and so on.

Then, the control unit 140 determines whether or not the driver is covered by the insurance, based on the acquired attribute (step S802). For example, in a case where the vehicle insurance covers the owner and the owner's spouse, the control unit 140 determines that the driver is covered by the insurance when the attribute of the driver is the attribute indicating the owner or the owner's spouse. On the other hand, in a case where the attribute of the driver is the attribute indicating the owner's child, the control unit 140 determines that the driver is not covered by the insurance.

In a case where it is determined that the driver is covered by the insurance (step S802: YES), the control unit 140 permits the processing related to the vehicle movement to the driver (step S803). On the other hand, in a case where it is determined that the driver is not covered by the insurance (step S802: NO), the control unit 140 does not permit the processing related to the vehicle movement to the driver (step S804).

### Technical Effect

Next, a technical effect obtained by the information processing system 10 according to the eighth example embodiment will be described.

As described in FIG. 12, in the information processing system 10 according to the eighth example embodiment, in a case where the driver is covered by the vehicle insurance, the processing related to the vehicle movement is permitted. In this way, it is possible to prevent the driver who is not covered by the insurance from driving the vehicle.

### Ninth Example Embodiment

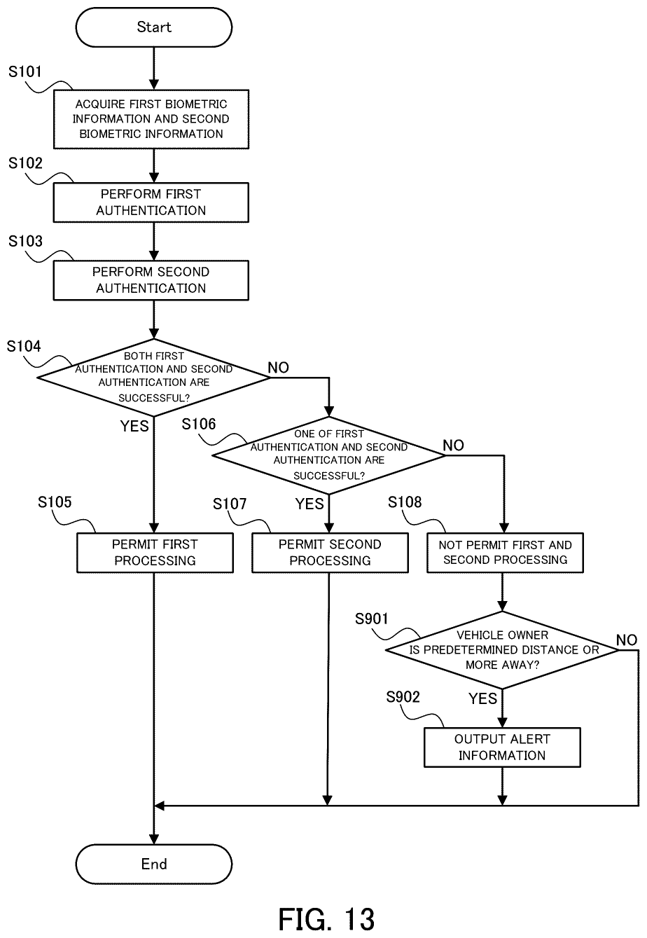

The information processing system 10 according to a ninth example embodiment is described with reference to FIG. 13. The ninth example embodiment partially differs from the first to eighth example embodiments described above only in its operation, and may be the same as the first to eighth example embodiments in the other parts. For this reason, a part differing from each of the example embodiments described above will be described in detail below, and a description of the other overlapping parts will be omitted as appropriate.

### Alert Output Operation

First, with reference to FIG. 13, a flow of an alert output operation (i.e., an operation related to processing of outputting alert information based on an authentication result) in the information processing system 10 according to the ninth example embodiment will be described. FIG. 13 is a flowchart illustrating the flow of the operation of the information processing system according to the ninth example embodiment.

As illustrated in FIG. 13, when the operation of the information processing system 10 according to the ninth example embodiment is started, as in the first example embodiment already described, the step S101 to the step S108 are performed. That is, based on the results of the first authentication using the first biometric information and the second authentication using the second biometric information, the operation of permitting various types of processing in the vehicle is performed.

Especially in the ninth example embodiment, in a case where it is determined that neither the first authentication nor the second authentication is successful (step S104: NO) and the first processing and the second processing in the vehicle are not permitted (step S108), the control unit 140 determines whether or not the vehicle owner is a predetermined distance or more away from the vehicle (step S901). Here, the “predetermined distance” is a value set as a threshold for determining whether or not the owner cannot see the vehicle. In a case where both the first authentication and the second authentication of the target are not successful while the owner is a predetermined distance or more away, it can be determined that there is a possibility that a suspicious person is approaching (or is in) the vehicle.

In a case where it is determined that the vehicle owner is a predetermined distance or more away from the vehicle (step S901: YES), the control unit 140 outputs alert information to the vehicle owner (step S902). The alert information may be outputted as an alarm sound from the vehicle, for example. Alternatively, the alert information may be outputted to a terminal carried by the owner (e.g., a smartphone, etc.). The alert information may also include biometric information on the target. For example, the alert information may include a face image or an iris image of the target. Furthermore, when the alert information is outputted, the vehicle engine may not be started without the owner's approval. In a case where it is determined that the vehicle owner is not a predetermined distance or more away from the vehicle (step S901: NO), the step S902 described above is omitted. That is, the control unit 140 does not output the alert information.

### Technical Effect

Next, a technical effect obtained by the information processing system 10 according to the ninth example embodiment will be described.

As described in FIG. 13, in the information processing system 10 according to the ninth example embodiment, the alert information is outputted in a case where the first authentication and the second authentication of the target are not successful while the owner is away from the vehicle. In this way, it is possible to detect a suspicious person approaching the vehicle (e.g., a thief intending to steal the vehicle, etc.) and notify the vehicle owner. In addition, by including the biometric information on the target in the alert information, it may be used as evidence to identify the suspicious person.

A processing method that is executed on a computer by recording, on a recording medium, a program for permitting the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### Supplementary Notes

The example embodiments described above may be further described as, but not limited to, the following Supplementary Notes below.

### Supplementary Note 1

An information processing system according to Supplementary Note 1 is an information processing system including: an acquisition unit that acquires first biometric information and second biometric information from a target using a moving body; a first authentication unit that determines whether or not the target is authenticatable by first authentication using the first biometric information; a second authentication unit that determines whether or not the target is authenticatable by second authentication using the second biometric information; and a control unit (i) that permits first processing in the moving body in response to a determination that it is authenticatable in both the first authentication and the second authentication, (ii) that permits second processing that is different from the first processing in response to a determination that it is authenticatable in one of the first authentication and the second authentication, and (iii) that does not permit the first processing and the second processing in response to a determination that it is not authenticatable in both the first authentication and the second authentication.

### Supplementary Note 2

An information processing system according to Supplementary Note 2 is the information processing system according to Supplementary Note 1, further including: an attribute identification unit that identifies an attribute of the target, based on an authentication result of at least one of the first authentication and the second authentication, wherein the control unit permits the first processing and the second processing, based on authentication results of the first authentication and the second authentication and based on the attribute.

### Supplementary Note 3

An information processing system according to Supplementary Note 3 is the information processing system according to Supplementary Note 2, wherein the control unit permits processing related to a movement of the moving body, to a target whose attribute is a first attribute, and permits processing that is different from the processing related to the movement of the moving body, to a target whose attribute is a second attribute.

### Supplementary Note 4

An information processing system according to Supplementary Note 4 is the information processing system according to Supplementary Note 3, wherein the control unit permits processing related to entry/exit of the moving body, to a target whose attribute is a third attribute.

### supplementary Note 5

An information processing system according to Supplementary Note 5 is the information processing system according to Supplementary Note 3 or 4, wherein the control unit permits the processing related to the movement of the moving body, to a target whose attribute is a fourth attribute, in a case where a driver of the moving body has an abnormality or in a case where permission is given by the driver.

### Supplementary Note 6

An information processing system according to Supplementary Note 6 is the information processing system according to Supplementary Note 5, further including: an abnormality detection unit that detects that the driver has an abnormality, based on at least one of the first biometric information and the second biometric information, wherein the control unit permits the processing related to the movement of the moving body, to the target whose attribute is the fourth attribute, based on a detection result of the abnormality detection unit.

### Supplementary Note 7

An information processing system according to Supplementary Note 7 is the information processing system according to any one of Supplementary Notes 2 to 6, wherein the control unit permits processing of disclosing information about the moving body, to a target whose attribute is a fifth attribute.

### Supplementary Note 8

An information processing system according to Supplementary Note 8 is the information processing system according to Supplementary Note 7, wherein the control unit permits processing related to an insurance renewal procedure, to the target whose attribute is the fifth attribute, in a case where insurance of the moving body has expired.

### Supplementary Note 9

An information processing system according to Supplementary Note 9 is the information processing system according to any one of Supplementary Notes 2 to 8, wherein the control unit determines whether or not a driver of the moving body is covered by insurance of the moving body, based on the attribute of the driver, and permits processing related to a movement of the moving body in a case where the driver is covered by the insurance.

### Supplementary Note 10

An information processing system according to Supplementary Note 10 is the information processing system according to any one of Supplementary Notes 1 to 9, wherein the control unit outputs alert information to an owner of the moving body, in response to the determination that it is not authenticatable in both the first authentication and the second authentication while an owner of the moving body is a predetermined distance or more away from the moving body.

### Supplementary Note 11

An information processing system according to Supplementary Note 11 is the information processing system according to Supplementary Note 10, wherein the alert information includes at least one of the first biometric information and the second biometric information on the target for whom it is determined that it is not authenticatable in both the first authentication and the second authentication.

### Supplementary Note 12

An information processing method according to Supplementary Note 12 is an information processing method that is executed by at least one computer, the information processing including: acquiring first biometric information and second biometric information from a target using a moving body; determining whether or not the target is authenticatable by first authentication using the first biometric information; determining whether or not the target is authenticatable by second authentication using the second biometric information; and (i) permitting first processing in the moving body in response to a determination that it is authenticatable in both the first authentication and the second authentication, (ii) permitting second processing that is different from the first processing in response to a determination that it is authenticatable in one of the first authentication and the second authentication, and (iii) not permitting the first processing and the second processing in response to a determination that it is not authenticatable in both the first authentication and the second authentication.

### Supplementary Note 13

A recording medium according to Supplementary Note 13 is a recording medium on which a computer program that allows at least one computer to execute an information processing method is recorded, the information processing method including: acquiring first biometric information and second biometric information from a target using a moving body; determining whether or not the target is authenticatable by first authentication using the first biometric information; determining whether or not the target is authenticatable by second authentication using the second biometric information; and (i) permitting first processing in the moving body in response to a determination that it is authenticatable in both the first authentication and the second authentication, (ii) permitting second processing that is different from the first processing in response to a determination that it is authenticatable in one of the first authentication and the second authentication, and (iii) not permitting the first processing and the second processing in response to a determination that it is not authenticatable in both the first authentication and the second authentication.

### Supplementary Note 14

A computer program according to Supplementary Note 14 is a computer program that allows at least one computer to execute an information processing method, the information processing method including: acquiring first biometric information and second biometric information from a target using a moving body; determining whether or not the target is authenticatable by first authentication using the first biometric information; determining whether or not the target is authenticatable by second authentication using the second biometric information; and (i) permitting first processing in the moving body in response to a determination that it is authenticatable in both the first authentication and the second authentication, (ii) permitting second processing that is different from the first processing in response to a determination that it is authenticatable in one of the first authentication and the second authentication, and (iii) not permitting the first processing and the second processing in response to a determination that it is not authenticatable in both the first authentication and the second authentication.

The present disclosure is permitted to be changed, if desired, without departing from the essence or spirit of this disclosure which can be read from the claims and the entire specification. An information processing system, an information processing method, and a recording medium with such changes are also intended to be within the technical scope of the present disclosure.

### DESCRIPTION OF REFERENCE CODES

10 Information processing system
110 Biometric information acquisition unit
120 First authentication unit
130 Second authentication unit
140 Control unit
150 Attribute identification unit
160 Abnormality detection unit

What is claimed is:

1. An information processing system comprising:
at least one memory that is configured to store instructions; and
at least one processor that is configured to execute the instructions to:
acquire first biometric information and second biometric information from a target using a moving body;
determine whether or not the target is authenticatable by first authentication using the first biometric information;
determine whether or not the target is authenticatable by second authentication using the second biometric information; and
(i) permit first processing in the moving body in response to a determination that it is authenticatable in both the first authentication and the second authentication, (ii) permit second processing that is different from the first processing in response to a determination that it is authenticatable in one of the first authentication and the second authentication, and (iii) not permit the first processing and the second processing in response to a determination that it is not authenticatable in both the first authentication and the second authentication.

2. The information processing system according to claim 1, wherein the at least one processor is configured to execute the instructions to:
identify an attribute of the target, based on an authentication result of at least one of the first authentication and the second authentication; and
permit the first processing and the second processing, based on authentication results of the first authentication and the second authentication and based on the attribute.

3. The information processing system according to claim 2, wherein the at least one processor is configured to execute the instructions to:
Permit processing related to a movement of the moving body, to a target whose attribute is a first attribute; and
Permit processing that is different from the processing related to the movement of the moving body, to a target whose attribute is a second attribute.

4. The information processing system according to claim 3, wherein the at least one processor is configured to execute the instructions to permit processing related to entry/exit of the moving body, to a target whose attribute is a third attribute.

5. The information processing system according to claim 3, wherein the at least one processor is configured to execute the instructions to permit the processing related to the movement of the moving body, to a target whose attribute is a fourth attribute, in a case where a driver of the moving body has an abnormality or in a case where permission is given by the driver.

6. The information processing system according to claim 5, wherein the at least one processor is configured to execute the instructions to:
detect that the driver has an abnormality, based on at least one of the first biometric information and the second biometric information; and
permit the processing related to the movement of the moving body, to the target whose attribute is the fourth attribute, based on a detection result.

7. The information processing system according to claim 2, wherein the at least one processor is configured to execute the instructions to permit processing of disclosing information about the moving body, to a target whose attribute is a fifth attribute.

8. The information processing system according to claim 7, wherein the at least one processor is configured to execute the instructions to permit processing related to an insurance renewal procedure, to the target whose attribute is the fifth attribute, in a case where insurance of the moving body has expired.

9. The information processing system according to claim 2, wherein the at least one processor is configured to execute the instructions to determine whether or not a driver of the moving body is covered by insurance of the moving body, based on the attribute of the driver, and permit processing related to a movement of the moving body in a case where the driver is covered by the insurance.

10. The information processing system according to claim 1, wherein the at least one processor is configured to execute the instructions to output alert information to an owner of the moving body, in response to the determination that it is not authenticatable in both the first authentication and the second authentication while an owner of the moving body is a predetermined distance or more away from the moving body.

11. The information processing system according to claim 10, wherein the alert information includes at least one of the first biometric information and the second biometric information on the target for whom it is determined that it is not authenticatable in both the first authentication and the second authentication.

12. An information processing method that is executed by at least one computer, the information processing comprising:
acquiring first biometric information and second biometric information from a target using a moving body;
determining whether or not the target is authenticatable by first authentication using the first biometric information;
determining whether or not the target is authenticatable by second authentication using the second biometric information; and
(i) permitting first processing in the moving body in response to a determination that it is authenticatable in both the first authentication and the second authentication, (ii) permitting second processing that is different from the first processing in response to a determination that it is authenticatable in one of the first authentication and the second authentication, and (iii) not permitting the first processing and the second processing in response to a determination that it is not authenticatable in both the first authentication and the second authentication.

13. A non-transitory recording medium on which a computer program that allows at least one computer to execute an information processing method is recorded, the information processing method including:
acquiring first biometric information and second biometric information from a target using a moving body;
determining whether or not the target is authenticatable by first authentication using the first biometric information;
determining whether or not the target is authenticatable by second authentication using the second biometric information; and
(i) permitting first processing in the moving body in response to a determination that it is authenticatable in both the first authentication and the second authentication, (ii) permitting second processing that is different from the first processing in response to a determination that it is authenticatable in one of the first authentication and the second authentication, and (iii) not permitting the first processing and the second processing in response to a determination that it is not authenticatable in both the first authentication and the second authentication.
